(19) United States
(12) Patent Application Publication
(10) Pub. No.: US 2006/0028585 A1
(43) Pub. Date: Feb. 9, 2006

(54) Multi-faceted electronic video display structure for organizing and displaying electronic device components

(76) Inventors: Edward W. Schulz, St. Charles, MO (US); Edward C. Schulz, St. Charles, MO (US)

Correspondence Address: MCCRACKEN & FRANK LLP, 200 W. ADAMS STREET, SUITE 2150, CHICAGO, IL, 60606, US

(21) Appl. No.: 11/199,650

(22) Filed: Aug. 9, 2005

Related U.S. Application Data
(60) Provisional application No. 60/600,030, filed on Aug. 9, 2004.

(51) Int. Cl. H04N 9/74

(52) U.S. Cl. 348/585

(57) ABSTRACT

A multi-console, multi-display, electronic video storage structure, such as a multi-faceted electronic video display structure, used for arranging, organizing and displaying various electronic devices is provided by the present invention. Illustratively, each structure has an open vertical core structure, from which radiates a multiplicity of congruent arc-segment-shaped storage compartment-units, consisting of an interior concave surface and an exterior convex surface. Each arc-segment-shaped storage compartment-unit may, for example, consists of multiple, vertically-oriented sub-compartments for arranging electronic components and related materials, including an upper series of one or more sub-compartments, one or more interior storage compartments, and a base-level, component storage/access sub-compartment. The mid-level video-display sub-compartment may also include an opening of the exterior convex surface to allow visual access to the electronic video display. The top portion may also include a cover attached at opposing ends of arc-segment-shaped structure. Each of the several base-level, component storage/access sub-compartments may also have a locking cover spanning its exterior convex surface that is hingedly attached to one end of the arc-segment-shaped structure. The interior concave surface of each the various vertically-oriented sub-compartments contain perforations of varying sizes and locations to permit the passage of cabling devices.

### CROSS REFERENCE TO RELATED APPLICATIONS

This application claims the benefit of U.S. Provisional Application No. 60/600,030, filed Aug. 9, 2004. This application is hereby incorporated herein by reference in their entireties.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

This invention relates to apparatuses, devices, systems, programs, kits, and/or methods for organizing and/or retaining a variety of electronic devices including, for example, video gaming units used in a video game parlor or arcade.

2. Description of the Background of the Invention

Numerous entertainment centers are available in the market place having a variety of storage features for household or electronic products such as televisions (TVs), radio receivers, compact disc players, etc. However, the entertainment centers now available are for use by individuals in a household setting and have a limited storage and display capability. They are not suited for use by larger groups of individuals and are unable to store and display the electronic devices needed for a larger setting, for example, a video game parlor.

For example, U.S. Pat. No. 3,467,455 issued to Caldemeyer discloses an entertainment center having a TV stand which rotates on its axis and includes mounts which provides similar rotation for speakers disposed on left and right sides of the TV housing and stand. The center contains two lower sliding drawers and four hindged cabinets for storing various items.

U.S. Pat. No. 4,471,586 issued to Schuch et al. discloses an independent shop in the form of a newspaper kiosk comprising a cell of trapezoidal shape and having a supporting structure formed by at least four supporting posts located at the four corners of the trapezium. The structure includes a network of interconnected cross-members as a roof framework. The posts act as supports for mounting product display box structures.

U.S. Pat. No. 4,702,534 issued to Witt et al. discloses a winged display case having a center enclosure, suited for containing trophies or other memorabilia, equipped with hinge, mounted opposite glass faced picture mounting wings. The center enclosure is made of a number of different shaped structures.

U.S. Design patents issued to Freeman (Des. 244,820), Short (Des. 340,152), Williams (Des. 346,695), Todd et al. (Des. 354,638), Hatrick-Smith (Des. 367,383) disclose ornamental design features of entertainment centers of general relevance to the TV center organizer as herein described. The French Patent No. 2 444 422 issued to Pellini discloses common features generally related to entertainment centers, including hinged outer shelves which rotate outward on left and right sides of a central shelf area for storing additional items.

Thus an organizer solving the aforementioned problems is desired.

### SUMMARY OF THE INVENTION

The present invention is directed to an organizer for electronic devices and corresponding storage media. In one embodiment of the present invention, the electronic device organizer includes a group of component organizers arranged in a shape used for organizing and retaining one or more electronic devices including, for example, a plurality of video display units, one or more control units and electronic circuitry appropriate for the encoding, sending, receiving, processing, decoding, and displaying of data as used in various games, such as, for example, Playstation® 2, Xbox®, Halo®, and/or Nintendo Game Cube®, in which one ore more players can participate. Through electronic encoding, transmitting, receiving, processing, decoding, and/or displaying, the games can be substantially instantaneously displayed in one or more places, for example, on a video display panel, a television screen, and/or a video monitor, and/or stored in an appropriate media for access at a later time. The multi-video display system of the present invention can also contain manually operated controls that affect the game data used in interacting and playing a game.

In one embodiment of the present invention, a multi-video display system includes a central shell structure optionally having one or more top portions; one or more central storage compartments for one ore more display boards, television screens, and/or video monitors; one or more interior storage compartments; and/or one or more base portions. Illustratively, the one or more top portions can include a cover attached at opposing ends of the central shell structure. The one or more interior storage compartments may each independently have one or more locking storage covers hingedly attached to the central shell structure. In yet another embodiment, the one or more base portions can have a smaller surface area than the surface area of the one or more top portions. Illustratively, each component organizer is triangular in shape. The resulting structure in one embodiment of the present invention provides the storage and display capacity needed for the larger setting of a video game parlor or arcade. The multi-video display system comprising one or more component organizers may be arranged in a variety of shapes and sizes including, for example, a polygon of various shapes and sizes, including, for example, a shape of 3 to 256 sides, or more, depending on the application desired. Illustratively, shapes can include a triangle, a square, a pentagon, a hexagon, a heptagon, and/or an octagon, with one of more sides substantially equal in length.

In yet another embodiment of the present invention, the invention provides an organizer having maximum storage capacity, and less material requirements. In yet another embodiment, the elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a front perspective view of a single component organizer of an exemplary entertainment center according to an embodiment of this invention showing a door in an open position.

FIG. 2 is a front perspective view of a single component organizer of an exemplary entertainment center according to an embodiment of this invention showing a door in a closed position.

FIG. 3 is a front elevational view of an exemplary entertainment center according to an embodiment of this invention.

FIG. 4 is a plan view of a component organizer of FIG. 3.

Similar reference characters denote corresponding features consistently throughout the attached drawings.

### DETAILED DESCRIPTION

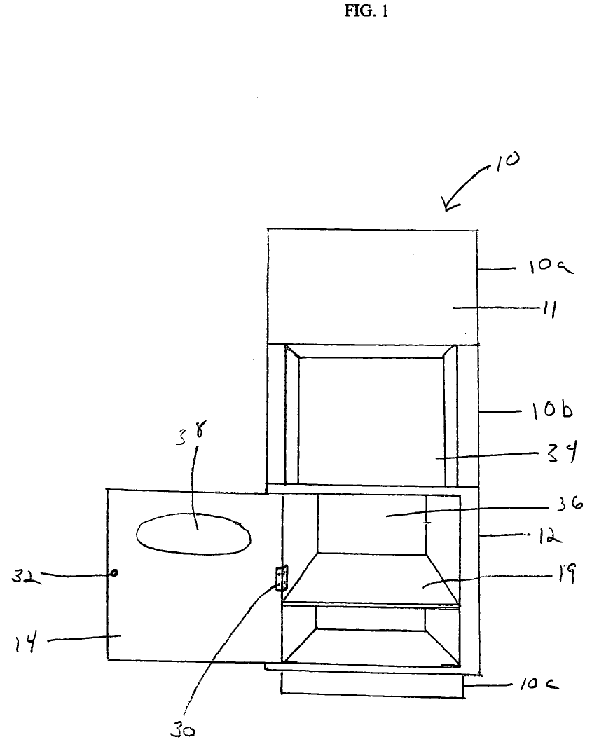

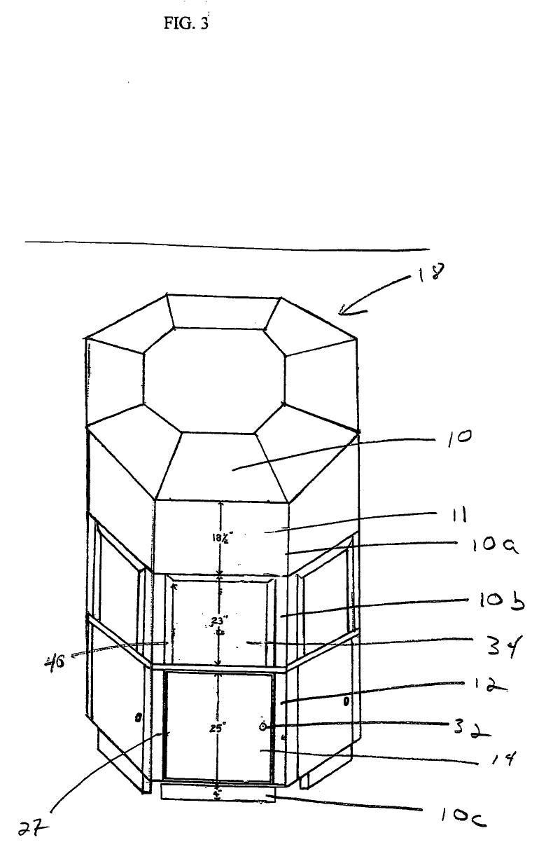

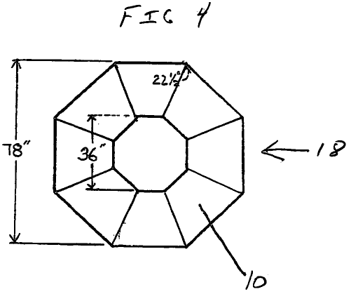

The present invention is directed to a system for organizing and retaining a variety of electronic devices such as one or more video game systems or the like and corresponding storage media. Embodiments of the present invention are depicted in FIGS. 1-4 and discussed below.

In one embodiment of the present invention, an organizer for electronic devices and corresponding storage media is provided. Illustratively, the electronic device organizer includes a group of component organizers arranged in a shape used for organizing and retaining one or more electronic devices including, for example, one or more control units and electronic circuitry appropriate for the encoding, sending, receiving, processing, decoding, and/or displaying of data as used in various games, such as, for example, Playstation® 2, Xbox®, Halo®, and/or Nintendo Game Cube®, in which one ore more players can participate. Other games useful in the present invention include any game adaptable to a video medium, including, for example, card games, such as, for example, blackjack or poker, chess, checkers, roulette, monopoly, trivial pursuit, etc. Through electronic encoding, transmitting, receiving, processing, decoding, and/or displaying, the games can be substantially instantaneously displayed in one or more places including, for example, on a video display unit, which may include, for example, a display board, a television screen, and/or a video monitor. The component organizer in one embodiment can also contain a console for manually operated controls including, for example, a keyboard, a joystick, a pointer, and/or a computer mouse, that affect the game data used in interacting and playing the game.

In one embodiment of the present invention, a component organizer includes a central shell structure optionally having one or more top portions; one or more central storage compartments for one or more video display units (for example, a display board, a television screen, and/or a video monitor); one or more interior storage compartments; and/or one or more base portions. Illustratively, the one or more top portions can include a cover attached at opposing ends of the central shell structure. The one or more interior storage compartments may each independently have one or more locking storage covers hingedly attached to the central shell structure. In yet another embodiment, one or more base portions can have the same, smaller, or larger surface area than the surface area of the one or more top portions. Illustratively, each component organizer is substantially a shape comprising a V-shape, a square-shape, a polygonal-shape, for example, a pentagon-shape, a hexagon-shape, a heptagon-shape, or an octagon-shaped, an oval-shape, a round-shape, or an ellipsoid-shape. One or more sides of the shape may be substantially equal in length. The resulting structure in one embodiment provides the storage and display capacity needed for the larger setting of a video game parlor or arcade. A multi-video display system of the present invention comprising one or more component organizers may be arranged in a variety of shapes and sizes including, for example, a polygon of various shapes and sizes, including, for example, a shape of 3 to 256 sides, or more, depending on the application desired, and may be spirally or circularly oriented. Illustratively, shapes can include a triangle, a square, a pentagon, a hexagon, a heptagon, and/or an octagon. The sides of an individual component may or may not be equal in length depending on the particular shape or size desired.

In accordance with various features of the present invention, an electronic displaying device, together with one or more data input units and appropriate electronic circuitry for encoding, sending, receiving, processing, decoding, and/or displaying of data as used in various games, such as, for example, Playstation® 2, Xbox®, Halo®, and/or Nintendo Game Cube®, or the like, is provided. In this embodiment, the particular game can be designed to automate and display the pertinent information of the game in such a manner as to allow more than one of the games to be played individually or simultaneously by one or more players in a substantially simultaneous manner. In yet another embodiment the data from one or more players can be stored in an appropriate storage media that can then be accessed immediately and/or at a later time by the original player or by another player. In still another embodiment, one or more players may access and play one or more games of the multi-video display system of the present invention remotely via, for example, the Internet.

One or more portions of a transmitting device useful in the present invention can be contained in any suitable housing having appropriate accommodations for the necessary inputs and outputs, such as, for example, a computer keyboard, a joystick, a pointer, a mouse, and/or and external power. In one embodiment, data transmission output can be accomplished wirelessly, as by an antenna or optically, for example, or through a cable, for example, coaxial cable, and/or a wire, for example, electrical wiring, as well as other methods known to those skilled in the art. One or more switches corresponding to various games can also be associated with the transmitting portion.

Illustratively, a receiver device in the present invention receives and decodes the encoded data into signals that are then displayed to present a graphical and/or numeric display of the data on one or more video display units such as, for example, a cathode ray tubes (CRT), a light emitting diode (LED), a liquid crystal displays (LCD), and/or a video or television display monitor. The video display unit in one embodiment of the present invention is positioned ergonomically for viewing by gamers. A video signal source is operably interconnected to the video display unit. The video signal source can also comprise a playback device. The video display unit can also be interconnected to the video source by a cable in one embodiment of the present invention. Illustratively, the video display unit can include one or more receivers and the video signal source can include one or more transmitters adapted to transmit a multimedia signal to the video display unit receiver. A wireless interconnection is thereby formed between the video source transmitter and the video display unit receiver.

In making the present invention ergonomically adaptable to an individual gamer, a video display unit can be adapted to move between a retracted and extended position via a bracket or slide mechanism. The video display unit can also be pivotally mounted to the bracket or slide mechanism for rotation between a range of ergonomic viewing angles. A detent mechanism can be formed between the bracket or slide mechanism and the video display unit for retaining the video display unit in a particular pre-selected rotational position relative to the bracket or slide mechanism. Adjustably mounting the video display unit about one or more pivot axes as well as in a vertically-adjustable manner allows the height, angle, and/or pivot of the video display unit to be easily adjusted by an individual gamer allowing for consideration of the location of the viewer as well as the age, height, and/or vision ability of the viewer in playing a game and/or interacting with the component organizer.

In yet another embodiment of the present invention, the video display unit is slidably mounted within a housing mounted to the component organizer for continuous adjustment between a stored position wherein the video display unit is located within the housing and a fully extended position wherein the video display is axially extended from the housing.

In yet another embodiment of the present invention, the video display unit is telescopically mounted within a housing mounted to the component organizer for continuous adjustment between a stored position wherein the video display unit is located within the housing and a fully extended position wherein the video display is axially extended from the housing.

It is also contemplated that the video display unit can include video driver software as is conventionally known in the art to maintain a vertically upright image on the video display unit screen regardless of whether the video display unit is positioned in an upright or inverted position. These types of video drivers typically operate by including a sensor located within the video display unit that senses the orientation of the video display and adjusts the signal to the screen of the video display unit corresponding thereto.

A component organizer of the present invention may also include in one embodiment of the present invention one or more jacks operably interconnected to the video display unit for receiving a signal from an alternate video and/or audio source. The alternate video source can be, for example, a videocassette player, a gaming unit, and/or a television signal. Additionally, audio or stereo jacks can be provided on a component organizer for interconnecting with a video source.

A multi-video display system of the present invention may also include electrical interconnections located, for example, at the base portion of the multi-video display system for optionally interconnecting electrical, networking, data, video signal, or cellular telephone signals to appropriately-wired circuits located within the multi-video display system.

The video display unit can in one embodiment be interconnected to one or more video signal sources by a cable or wire, or in a wireless unit, by a wireless receiver in the video display unit and an associated transmitter located within the multi-video display system, for example.

As illustrated in FIGS. 1-4, an entertainment center organizer component or housing 18 of the present invention can comprise a central shell structure 10 having a top portion 10a with a cover 11 attached at opposing ends of said shell structure, a housing 10b for a video display panel 34, an interior storage compartment 12 with a locking storage cover 14 hingedly attached by a hinge 30 to the central shell structure, and a base portion 10c. Each organizer component is attached forming an octagonal shaped entertainment center 18.

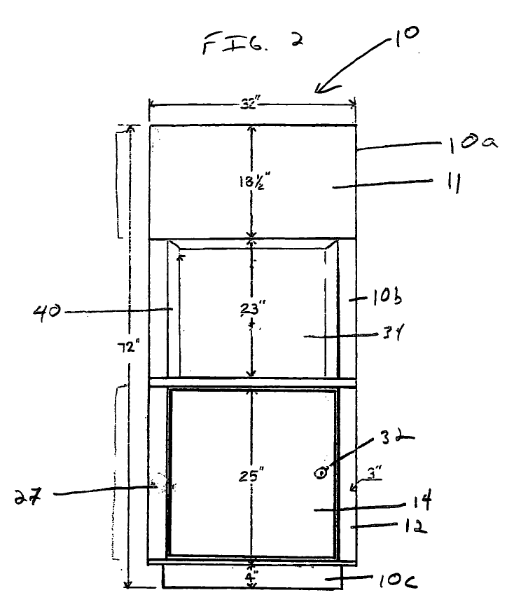

The locking storage cover 14 has a key lock 32 conceals the interior storage compartment 12 in a first or closed state as diagrammatically illustrated in FIG. 2 and provides access to the interior storage compartment 12 in a second or open state as shown in FIG. 1. A shelf 19 may also be located on the interior storage compartment 12 to hold various components (not shown).

The base portion 10c of the central shell structure 10 has a smaller surface area A_{L} than the surface area A_{S} of the top portion. The central shell structure 10 is constructed to form a substantially V-shaped housing or cavity for retaining a TV or video display panels 34 of various sizes. A rubber seal 40 may surround and secure the video display panel 34 to the housing 10b. Since dimension characteristics do not necessarily serve to distinguish the inventive features as herein described, one having ordinary skill in the art can provide the entertainment center organizer in any desired dimension as a matter of intended use.

As illustrated FIG. 1, shelf 19 is a tapered shelf decreasing in area from the front of the shell to the back portion 36 of the shell. With respect to first 11 and second 14 arcuate storage covers, they may be made of any desired material. In addition, cover 14 is hingedly attached to the interior storage compartment 12 at location 27. The entertainment center organizer component or housing 18 according to the invention is made out of one or more opaque materials including, for example, wood, a polymer, corrugated cardboard, metal, acrylic, polyethylene, polyurethane, nylon, fiber glass, polypropylene, or plastic, or any combination thereof according to a predetermined aesthetical preference or appeal. One or more translucent areas 38 may be provided in the central shell structure 10 to provide an opening to view the interior of the central shell structure.

In one embodiment of the present invention, the entertainment center is octagon shaped, that is, an eight-sided entertainment unit, that includes eight video display panels, such as a television monitor, with full game systems and one or more controllers for each video display panel. In this embodiment, one to as many as 16 players or more, can play at one time, in for example, a tournament or in league play. Game play can include, for example, Playstation® 2, Xbox®, Halo®, and/or Nintendo Game Cube®. In yet another embodiment, the games, including, for example, Halo®, can be operatively linked and played with other gamers.

Illustratively, one to several players per video display panel can play at one time depending on the particular game being played. For example, at each video-display system, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 1,000, 10,000, 100,000, 1,000,000, 10,000,000, people, or any multiple (for example, multiples of 2, 3, 4, 5, 5, 7, 8, 9, or 10) or addition thereof, per video display unit can be playing at each video-display system. In a video-display system with eight video display panels, for example, an octagon shaped video display system with a video display panel at each side of the octagon, or a sixteen-sided shape with video display panels located at eight of the sixteen sides, as few as eight players may be playing at one time when every video display panel is being played by a gamer and when there are two gamers per video display panel, sixteen gamers may be playing at each video-display system. It is contemplated that even higher numbers of gamers can play at each video display system depending on the size and shape of the video display system and the number of gamers per video display panel.

The present invention can also be used in conjunction with a wireless remote control system as described in, for example, U.S. Pat. No. 5,435,573, or touch sensitive video game controllers as described in, for example, U.S. Pat. No. 5,409,239.

In some embodiments of the present invention, an optional console is provided for the gamers to interact with one or more games, which includes, for example, interacting with a computer and controlling a computer display. Such consoles can also contain a computer keyboard, a joystick, a computer mouse, or other device to communicate with the game software or program.

Communication means to operably interconnect devices of the present invention can be by any means known to those skilled in the art and may include, for example, a hard wire means, a wireless means, and/or an optical means. Communication devices useful in the present invention include those described in U.S. Pat. No. 6,747,634. Other communication devises useful in the present invention include those described in U.S. Pat. No. 6,747,632. Other communication devises useful in the present invention include those described in U.S. Pat. No. 6,442,325. Other communication devises useful in the present invention include those described in U.S. Pat. No. 6,738,044. Other communication devises useful in the present invention include those described in U.S. Pat. No. 6,509,845. Other communication devises useful in the present invention include those described in U.S. Pat. No. 6,370,371. Other communication devises useful in the present invention include those described in U.S. Pat. No. 6,301,306. Other communication devises useful in the present invention include those described in U.S. Pat. No. 6,128,006. Other communication devises useful in the present invention include those described in U.S. Pat. No. 5,990,866.

In yet another embodiment of the present invention, one or more players may be on-line interacting with one or more of the games remotely, such as over the Internet or other LAN system (see, for example, U.S. Pat. No. 6,514,144).

Illustratively, a multi-video display system of the present invention comprises a plurality of video display panels to independently display an image. In one embodiment, each display panel comprises a display area for displaying a image, such as, for example, an image from a game such as Playstation® 2, Xbox®, Halo®, or Nintendo Game Cube®. The multi-video display system may also include a housing to contain one or more of the display panels, and each display panel may be independently fixedly mounted on the housing. In one embodiment, the housing contains at least three display panels and is circularly oriented for organizing and/or retaining one or more electronic devices. In yet another embodiment, the housing of the present invention comprises a central shell structure with one or more top portions, one or more storage compartments for containing one or more of the video display panels, one or more interior storage compartments, and one or more base portions. The central shell structure may also have one or more covers hingedly attached to the central shell structure, with one or more of covers optionally attached to, for example, an opposing end of the central shell structure. In yet another embodiment, the cover is attached to the central shell structure at a first and second top central location. The covers can be made of, for example, one or more opaque materials. In yet another embodiment, the base portion of the multi-video display system is a smaller surface area than the surface area of the top portion.

The multi-video display system of the present invention may also contain a central shell structure comprising one or more interior storage compartments for the video display panels. The interior storage compartments can also optionally comprise a locking storage cover hingedly attached, for example, to the central shell structure at a first and second top central location. The locking storage cover can in one embodiment by made of one or more opaque materials. Illustratively, the storage compartment is substantially a shape such as, for example, a V-shaped compartment, a square-shaped compartment, a pentagon-shaped compartment, a hexagon-shaped compartment, a heptagon-shaped compartment, an octagon-shaped compartment, an oval-shaped compartment, a round-shaped compartment, a serpentine-shaped compartment, or an ellipsoid-shaped compartment. Illustratively, the housing is substantially a shape comprising a 3 to 256 sided shape, including, for example, a substantially triangle, square, pentagon, hexagon, heptagon, or octagon shape.

In yet another embodiment of the present invention, the sides of a multi-video display system are a shape where two or more sides are substantially equal in length.

In still another embodiment of the present invention, the multi-video display system has at least three sides that each house at least one video display unit.

Illustratively, the multi-video display system of the present invention is made of one or more opaque materials, such as, for example, wood, polymer, corrugated cardboard, metal, acrylic, polyethylene, polyurethane, nylon, fiber glass, polypropylene, and/or plastic, or any combination thereof.

The multi-video display system of the present invention may also comprise one or more communication device ports for the display panels to communicate with at least one external or internal device. Illustratively, the one or more communication device ports comprises, for example, a universal serial bus control port or a RS-232 control port.

The multi-video display system of the present invention may also comprise one or more video inputs comprising, for example, a composite video input, an RGB video input, and/or an S-video (Y/C) input.

The multi-video display system of the present invention may also comprise at least one power unit for providing power to, for example, at least one display panels and/or one or more electronic devices.

The multi-video display system of the present invention may also comprise at least one computer keyboard, a computer joystick, a pointer, and/or a computer mouse.

Illustratively, a video display panel of the present invention comprises a cathode ray tube, a television monitor, a light emitting diode display, a liquid crystal display panel, a plasma display panel, and/or a digital display panel, or any combination thereof.

In another embodiment of the present invention, the one or more of the electronic devices of the present invention are in communication with at least one video display panels of the present invention.

Illustratively, an electronic device of the present invention comprises one or more control units or electronic circuitry, wherein the one or more control units or electronic circuitry is capable of at least one of encoding data, sending data, receiving data, processing data, decoding data, and/or displaying data on at least one of the video display panels. In one embodiment, control units and/or electronic circuitry is used in encoding, sending, receiving, processing, decoding, or displaying at least one game, such as, for example, Playstation® 2, Xbox®, Halo®, or Nintendo Game Cube®. The multi-video display system of the present invention can be played by one or more people.

In yet another embodiment of the present invention, the image displayed in the present invention may be substantially identically displayed on at least two of the video display panels.

A method of independently displaying one or more video images is also provided by the present invention. Illustratively, the method comprises fixedly mounting a plurality of video display panels to independently display an image, each display panel comprising a display area for displaying the image, in a housing to contain the plurality of display panels, the housing comprising at least three display panels and circularly oriented for at least one of organizing or retaining one or more electronic devices.

The present invention also embodies kits that comprise in one embodiment, a multi-video display system that comprises a plurality of video display panels to independently display an image, each display panel comprising a display area for displaying the image; and a housing to contain the plurality of display panels, the housing comprising at least three display panels and circularly oriented for at least one of organizing or retaining one or more electronic devices; and a set of instructions for using, maintaining, and/or assembling the multi-video display system.

In one embodiment, a multi-console, multi-display, electronic video storage structure, such as a multi-faceted electronic video display structure, used for arranging, organizing and displaying various electronic devices is also provided by the present invention. Illustratively, each structure has an open vertical core structure, from which radiates a multiplicity of congruent arc-segment-shaped storage compartment-units, consisting of an interior concave surface and an exterior convex surface. Each arc-segment-shaped storage compartment-unit in one embodiment consists of multiple, vertically-oriented sub-compartments for arranging electronic components and related materials, including, foe example, an upper series of one or more sub-compartments, one or more interior storage compartments, and/or a base-level, component storage/access sub-compartment. The mid-level video-display sub-compartment may optionally include an opening of the exterior convex surface to allow visual access to the electronic video display. The top portion in one embodiment may include a cover attached at opposing ends of arc-segment-shaped structure. In yet another embodiment, each of the several base-level, component storage/access sub-compartments optionally has a locking cover spanning its exterior convex surface that is hingedly attached to one end of the arc-segment-shaped structure. In still another embodiment of the present invention, the interior concave surface of each of the various vertically-oriented sub-compartments contains perforations of varying sizes and

In another embodiment of the present invention, the multi-video display system has one or more covers, housings, and/or locking storage covers made of one or more opaque materials. In yet another embodiment the game is played by at least one player. In yet another embodiment, the multi-video display system has at least three sides with each side housing at least one video display unit.

The invention has been described in an illustrative manner and it is to be understood the terminology used is intended to be in the nature of description rather than of limitation. All patents, published patent applications, and other references described herein are incorporated herein by reference as if they appear in this document in their entirety. Many modifications, equivalents, and variations of the present invention are possible in light of the above teachings, therefore, it is understood that within the scope of the below claims, the invention may be practiced other than specifically described.

In yet another embodiment of the present invention, the multi-video display system has one or more covers, housings, and/or locking storage covers made of one or more opaque materials. In yet another embodiment the game is played by at least one player. In yet another embodiment, the multi-video display system has at least three sides with each side housing at least one video display unit.

The invention has been described in an illustrative manner and it is to be understood the terminology used is intended to be in the nature of description rather than of limitation. All patents, published patent applications, and other references described herein are incorporated herein by reference as if they appear in this document in their entirety. Many modifications, equivalents, and variations of the present invention are possible in light of the above teachings, therefore, it is understood that within the scope of the below claims, the invention may be practiced other than specifically described.

We claim:

1. A multi-video display system comprising:
a plurality of video display panels to independently display an image, each display panel comprising a display area for displaying the image; and
a housing to contain the plurality of display panels, the housing comprising at least three display panels and circularly oriented for at least one of organizing or retaining one or more electronic devices;
wherein the plurality of display panels are fixedly mounted on the housing.

2. The multi-video display system of claim 1, wherein the housing comprises:
a central shell structure comprising one or more top portions, one or more storage compartments for one or more of the plurality of video display panels, one or more interior storage compartments, and one or more base portions.

3. The multi-video display system of claim 2, wherein the central shell structure further comprises one or more covers hingedly attached to the central shell structure; wherein one or more of the one or more covers are optionally attached to an opposing end of the central shell structure.

4. The multi-video display system of claim 3, wherein the cover is attached to the central shell structure at a first and second top central location.

5. The multi-video display system of claim 3, wherein the one or more covers is made of one or more opaque materials.

6. The multi-video display system of claim 2, wherein the central shell structure comprises one or more interior storage compartments for one or more of the plurality of video display panels; wherein the one or more interior storage compartments optionally comprise a locking storage cover hingedly attached to the central shell structure at a first and second top central location.

7. The multi-video display system of claim of claim 6, wherein the locking storage cover is made of one or more opaque materials.

8. The multi-video display system of claim 2, wherein the base portion comprises a smaller surface area than the surface area of the top portion.

9. The multi-video display system of claim 2, wherein the storage compartment is substantially a shape comprising a V-shaped compartment, square-shaped compartment, a pentagon-shaped compartment, a hexagon-shaped compartment, a heptagon-shaped compartment, an octagon-shaped compartment, a oval-shaped compartment, a round-shaped compartment, a serpentine-shaped compartment, or an ellipsoid-shaped compartment.

10. The multi-video display system of claim 1, wherein the housing is substantially a shape comprising a 3 to 256 sided shape.

11. The multi-video display system of claim 10, wherein the shape is substantially a triangle, a square, a pentagon, a hexagon, a heptagon, or an octagon.

12. The multi-video display system of claim 10, wherein the shape comprises two or more sides substantially equal in length.

13. The multi-video display system of claim 10, wherein the shape is substantially an octagon.

14. The multi-video display system of claim 13, wherein the octagon comprises sides substantially equal in length.

15. The multi-video display system of claim 10, wherein at least three sides of the multi-video display system each house at least one video display unit.

16. The multi-video display system of claim 1, wherein the housing is made of one or more opaque materials.

17. The multi-video display system of claim 1, wherein the housing comprises one or more areas made of at least one of wood, a polymer, corrugated cardboard, metal, acrylic, polyethylene, polyurethane, nylon, fiber glass, polypropylene, or plastic, or any combination thereof.

18. The multi-video display system of claim 1 further comprising one or more communication device ports for the display panels to communicate with at least one external or internal device.

19. The multi-video display system of claim 18, wherein the one or more communication device ports comprises a universal serial bus control port or a RS-232 control port.

20. The multi-video display system of claim 1 further comprising one or more video inputs comprising a composite video input, an RGB video input, or an S-video (Y/C) input.

21. The multi-video display system of claim 1 further comprising at least one power unit for providing power to at least one of the display panels or the one or more electronic devices.

22. The multi-video display system of claim 1 further comprising at least one computer keyboard, a computer joystick, a pointer, or a computer mouse.

23. The multi-video display system of claim 1, wherein one or more of the video display panels comprises a cathode ray tube, a television monitor, a light emitting diode display, a liquid crystal display panel, a plasma display panel, or a digital display panel, or a combination thereof.

24. The multi-video display system of claim 1, wherein the one or more of the electronic devices are in communication with at least one of the video display panels.

25. The multi-video display system of claim 24, wherein the electronic device comprises one or more of a control unit or electronic circuitry, wherein the one or more control units or electronic circuitry is capable of at least one of encoding data, sending data, receiving data, processing data, decoding data, or displaying data on at least one of the video display panels.

26. The multi-video display system of claim 25, wherein the one or more control units or electronic circuitry is used in encoding, sending, receiving, processing, decoding, or displaying at least one game comprising Playstation® 2, Xbox®, Halo®, or Nintendo Game Cube®.

27. The multi-video display system of claim 26, where the game is played by at least one player.

28. The multi-video display system of claim 1, wherein the image is substantially identically displayed on at least two of the video display panels.

29. A method of independently displaying one or more video images, the method comprises:
fixedly mounting a plurality of video display panels to independently display an image, each display panel comprising a display area for displaying the image, in a housing to contain the plurality of display panels, the housing comprising at least three display panels and circularly oriented for at least one of organizing or retaining one or more electronic devices.

30. The method of claim 28, wherein one or more of the video display panels comprises a television monitor, a liquid crystal display panel, a plasma display panel, or a digital display panel, or a combination thereof.

31. The method of claim 28, wherein the one or more of the electronic devices are in communication with at least one of the video display panels.

32. The method of claim 30, wherein the electronic device comprises one or more of a control unit or electronic circuitry, wherein the one or more control units or electronic circuitry is capable of at least one of encoding data, sending data, receiving data, processing data, decoding data, or displaying data on at least one of the video display panels.

33. The method of claim 31, wherein the one or more control units or electronic circuitry is used in encoding, sending, receiving, processing, decoding, or displaying at least one game comprising Playstation® 2, Xbox®, Halo®, or Nintendo Game Cube®.

34. The method of claim 32, where the game is played by at least one player.

35. A kit comprising:
a multi-video display system that comprises a plurality of video display panels to independently display an image, each display panel comprising a display area for displaying the image; and a housing to contain the plurality of display panels, the housing comprising at least three display panels and circularly oriented for at least one of organizing or retaining one or more electronic devices; and
a set of instructions for at least one of using, maintaining, or assembling the multi-video display system;
wherein the plurality of display panels are capable of being fixedly mounted on the housing.
